(19) United States
(12) Patent Application Publication
(10) Pub. No.: US 2009/0132676 A1
(43) Pub. Date: May 21, 2009

(54) COMMUNICATION DEVICE FOR WIRELESS VIRTUAL STORAGE AND METHOD THEREOF

(75) Inventors: Guan-Hua Tu, Taipei City (TW); Wei-Hsuan Lien, Taipei (TW)

Correspondence Address: SNELL & WILMER L.L.P. (Main), 400 EAST VAN BUREN, ONE ARIZONA CENTER, PHOENIX, AZ, 85004-2202, US

(73) Assignee: MEDIATEK, INC., Hsin-Chu (TW)

(21) Appl. No.: 11/942,812

(22) Filed: Nov. 20, 2007

(51) Int. Cl. G06F 15/16

(52) U.S. Cl. 709/217; 709/228

(57) ABSTRACT

A communication device capable of sharing data in a remote storage server with an electronic device is disclosed. The electronic device communicates with the remote storage server via the communication device. The communication device comprises a wireless communication module for communicating with the remote storage server with a communication protocol, an interface for communicating with the electronic device with an interface protocol, and a converter for generating a mapping table between two different transmission formats according to the communication protocol and the interface protocol.

### FIELD OF INVENTION

The invention is related to a communication device, and more particularly related to a method and a communication device capable of sharing data in a remote server with an electronic device.

### BACKGROUND OF THE INVENTION

Recently, multimedia has become a necessity in daily life. Especially, with the development of portable storage devices, such as a Universal Serial Bus (hereinafter referred to as USB) flash disk, an IEEE1394 flash disk, a mobile phone with a storage memory, or USB External Portable Hard Disk, large amounts of multimedia or other kinds of data may be carried from one device to another conveniently.

For example, most mobile phones support USB flash disk feature nowadays, and these type of mobile phones may share their local storage data, such as pictures, video clips, and mp3 files, stored in a flash memory to an electronic device, such as a personal computer, a notebook or a Personal Digital Assistant (PDA), through a USB interface. However, the capacity of the flash memory is limited, and the cost of flash memory is relatively high.

Accordingly, there is a need for a storage device with large capacity for a communication device.

### SUMMARY OF THE INVENTION

One aspect of the present invention is to provide a communication device capable of sharing data in a remote storage server with an electronic device. The electronic device can communicate with the remote storage server via the communication device. The communication device includes a wireless communication module for using a communication protocol to communicate with the remote storage server, an interface for communicating with the electronic device with an interface protocol, and a converter for generating a mapping table between two different transmission formats according to the communication protocol and the interface protocol.

Another aspect of the present invention is to provide a method for a communication device to share data in a remote storage server with an electronic device. The method includes the following steps: establishing a communication with the remote storage server by a communication protocol; establishing communication with the electronic device by an interface protocol; and generating a mapping table between two different transmission formats according to the communication protocol and the interface protocol.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying figures, wherein:

FIG. 1 illustrates a schematic diagram of a wireless virtual storage system in accordance with one embodiment of the present invention;

FIG. 2 illustrates an exemplary wireless virtual storage system in accordance with one embodiment of the present invention;

FIG. 3 illustrates operating processes among the mobile phone, the storage server and the computer in accordance with the embodiment shown in FIG. 2;

FIG. 4 illustrates operating processes among the mobile phone, the storage server and the computer in accordance with the embodiment shown in FIG. 2;

FIG. 5 illustrates operating processes among the mobile phone, the storage server and the computer in accordance with the embodiment shown in FIG. 2; and

FIG. 6 illustrates a software architecture of a wireless virtual storage system in accordance with one embodiment of the present invention.

### DETAILED DESCRIPTION

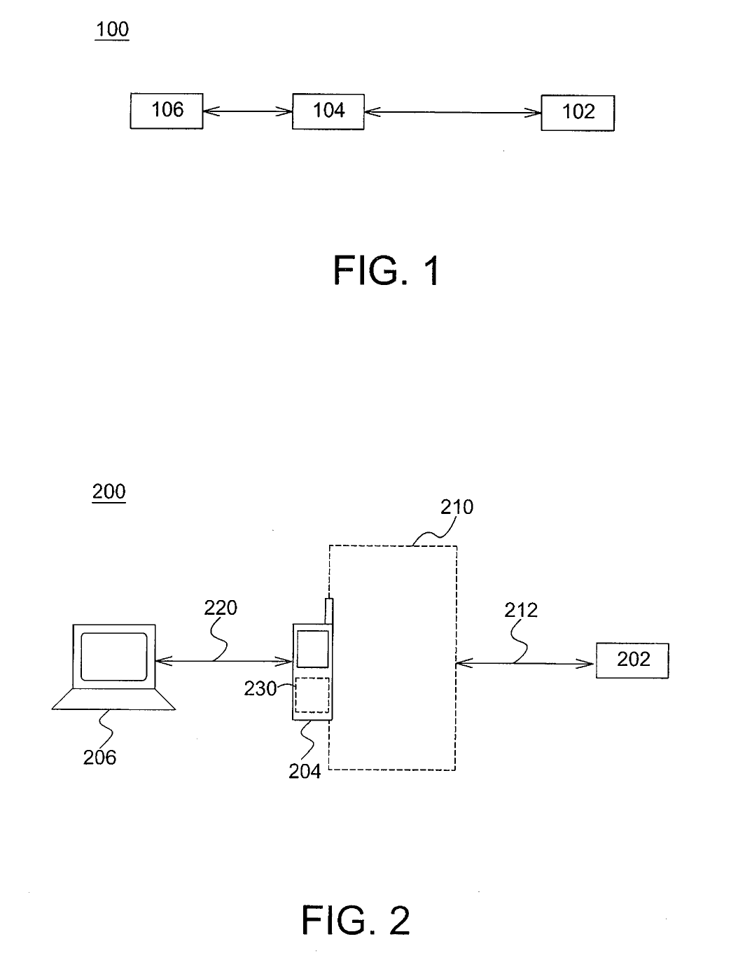

In order to accomplish the foregoing features and functions, the present invention discloses a system and a communication device for wireless virtual storage. The present invention will be described more fully hereinafter with reference to the FIGS. 1-6. However, the devices, elements, and methods in the following description are configured to illustrate the present invention, and should not be construed in a limiting sense.

Referring to FIG. 1, a wireless storage system 100 is disclosed. The wireless storage system 100 includes a remote storage server 102, a mobile phone 104, and an electronic device 106. The remote storage server 102 supports a communication protocol, such as Samba, File Transfer Protocol (hereinafter referred to as FTP) or Network File System (hereinafter referred to as NFS). The mobile phone 104 wirelessly connects with the remote storage server 102 for transmitting data with the remote storage server 102 using the communication protocol. In another embodiment, the mobile phone 104 may be a PDA or other communication devices as appropriate. The electronic device 106 connects with the mobile phone 104 via an interface using an interface protocol, such as a USB protocol or an IEEE1394 protocol. The electronic device 106 communicates with the remote storage server 102 via the mobile phone 104. The mobile phone 104 creates a mapping table between two different transmission formats based on the communication protocol between the remote storage server 102 and the mobile phone 104. After receiving file structure information of the remote storage server 102 from the remote storage server 102, the mobile phone 104 generates a virtual File Allocation Table (FAT) corresponding to the received file structure information. Then, the virtual FAT is transmitted to the electronic device 106. The electronic device 106 may transmit a request to the mobile phone 104 according to the virtual FAT for accessing data stored in the remote storage server 102, and then the mobile phone 140 may forward the request to the remote storage server 102 in an appropriate format according to the mapping table. After the mobile phone 104 receives a response corresponding to the request, the phone may transmit the response to the electronic device 106. In other words, the virtual FAT allows the electronic device 106 to access the data stored in the remote storage server 102 without concerning the protocol used by the remote storage server 102. The electronic device 106 in the present invention may be a notebook/laptop, a multiprocessor-based device, a microprocessor-based device, a programmable consumer electronic device or other electronic devices. Moreover, the remote storage server 102 may wirelessly connect with the mobile phone 104 through GSM network, GPRS network, 3G network, WLAN, WiMax network, IrDa network, etc.

Referring to FIG. 2, in one embodiment, a wireless storage system 200 includes a remote storage server 202, a mobile phone 204, and a computer 206. The mobile phone 204 may be connected to the computer 206 wiredly or wirelessly via a communication interface 220. For wired connection, the communication interface 220 may be a serial interface or a parallel interface. A serial interface, such as a RS232, RS242, Serial ATA (SATA), Universal Serial Bus (USB), IEEE 1394 or Universal Asynchronous Receiver Transmitter (UART) interface or similar, is an interface by which information is transferred in or out one bit at a time. A parallel port, such as an Integrated Drive Electronics (IDE), Small Computer System Interface (SCSI), IEEE 1284 interface or similar, is an interface which enables data to be transferred in or out in parallel, that is, on more than one wire. A parallel interface carries one bit on each wire thus multiplying the transfer rate obtainable over a single cable (contrast serial port). There are usually several extra wires on the parallel interface that are used for control signals to indicate when data are ready to be sent or received. For wireless connection, the communication interface 220 is an interface by which information is transferred by radio frequency or infrared signals or similar, and, for example, may be 802.x, Bluetooth or Infrared Data Association (IrDA) interface or similar.

The mobile phone 204 may wirelessly communicate with the remote storage server 202 through a wireless network 210, such as GSM network, GPRS network, 3G network, WLAN, WiMax network, IrDa network, or similar. The protocol 212 between the mobile phone 204 and the remote storage server 202 may be CIFS (common internet file system) protocol, FTP (file transfer protocol), NFS (Network File System) protocol, or similar.

In the embodiment shown in FIG. 2, when the mobile phone 204 connects to the computer 206, the computer 206 may transmit a command to the mobile phone 204 for accessing data, such as text files, image files, video files, as so on, stored in the remote storage server 202. The command is passed to the mobile phone 204 via the communication interface 220 to make the mobile phone 204 access the data in the remote storage server 202 through CIFS/FTP/NFS protocols, therefore the computer 206 doesn't need to be configured to access the remote storage server 202, i.e. the computer 206 can access easily the remote storage server 202 without any modification.

In the case of the communication interface 220 being USB interface, when the mobile phone 204 is plugged into the computer 206 through the USB interface, the computer 206 will ask the mobile phone 204 how many sectors are provided for getting a root directory block. Then, if the computer 206 is desired to download a file shown in the root directory block, it may transmit a read command with block address to the mobile phone 204 for requesting to read a certain block corresponding to the file. Before being transmitted to the remote storage server 202, the read command is received and converted into an appropriate format by the mobile phone 204 according to the protocol between the mobile phone 204 and the remote storage server 202. For example, under CIFS protocol, the format transmitted between the mobile phone 204 and the remote storage server 202 is file path, rather than block address, and therefore the read command should be converted from a block-address-based command to a file-path-based command. In this embodiment, the mobile phone 204 creates a mapping table for mapping between the block addresses and the file paths for allowing the computer 206 to access the data, which are shared with the mobile phone 204, stored in the remote storage server 202.

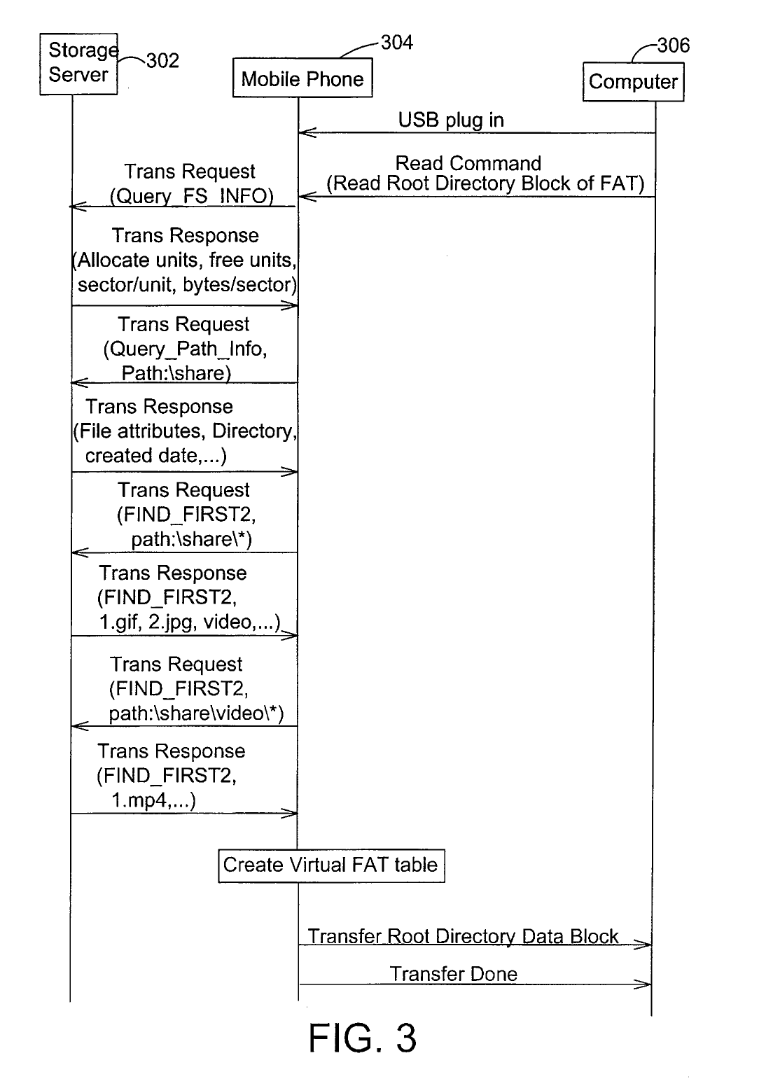

The details of preferred embodiments of interactions among a storage server 302, a mobile phone 304, and a computer 306 are shown in FIG. 3 to FIG. 5. For illustrative purpose, the storage server 302 is a Samba server using CIFS protocol and the communication protocol between the mobile phone 204 and the computer 306 is a USB protocol, but the present invention does not intend to limit the types of these protocols.

Referring to FIG. 3, when the mobile phone 304 is plugged in a USB interface of the computer 306, the computer 306 generally requests the mobile phone 304 to provide sector information in order to display the folder view. Therefore, the computer 306 transmits a read command to mobile phone 304 for reading the root directory block of a file allocation table. On the mobile phone 304 side, the mobile phone transmits a request based on CIFS protocol (such as Query_FS_INFO) to the storage server 302 for requesting the system information of the storage server 302. Then, the mobile phone 304 receives a response containing the information about how many units exist, how many units are free, how many sectors are in one unit, how many bytes are in one sector, etc., from the storage server 302. Next, the mobile phone 304 transmits a request (such as Query_Path_Info, Path:\share) to get the information about a folder “share.” Then, the mobile phone 304 receives a response containing the arguments of the folder “share,” such as file attributes, directory, created date, etc., from the storage server 302. Next, the mobile phone 304 transmits a request (such as FIND_FIRST2, Pattern:\share\*) to get the structure information under the folder “share.” Then, the mobile phone 304 receives a response showing which files or folders are present in the folder “share,” for example, there are file “1.gif”, file “2.jpg” and folder “video” in the folder “share.” Next, the mobile phone 304 transmits a request (such as FIND_FIRST2, Pattern:\share\video\*) to get the structure information under the folder “video.” Then, the mobile phone 304 receives a response showing which files or folders are present in the folder “video,” such as file “1.mp4” in this case. This collecting process is continued until the mobile phone 304 gets the whole information under the folder “share.” Then, a virtual File Allocation Table may be created by the mobile phone 304 based on the collected information of the folder “share,” and then transferred to the computer 306. The virtual FAT may be a part of a File Allocation Table (FAT) of the remote storage server. According to the virtual File Allocation Table, when the computer 306 desires to access the data stored in the folder “share” of the storage server 302, it transmits a block address to the mobile phone 304, and then the block address is transferred into another syntax corresponding to the communication protocol between the storage server 302 and the mobile phone 304 by the mobile phone 304 before transmitted to the storage server 302. In the case of CIFS protocol, the block address is transferred into a file path.

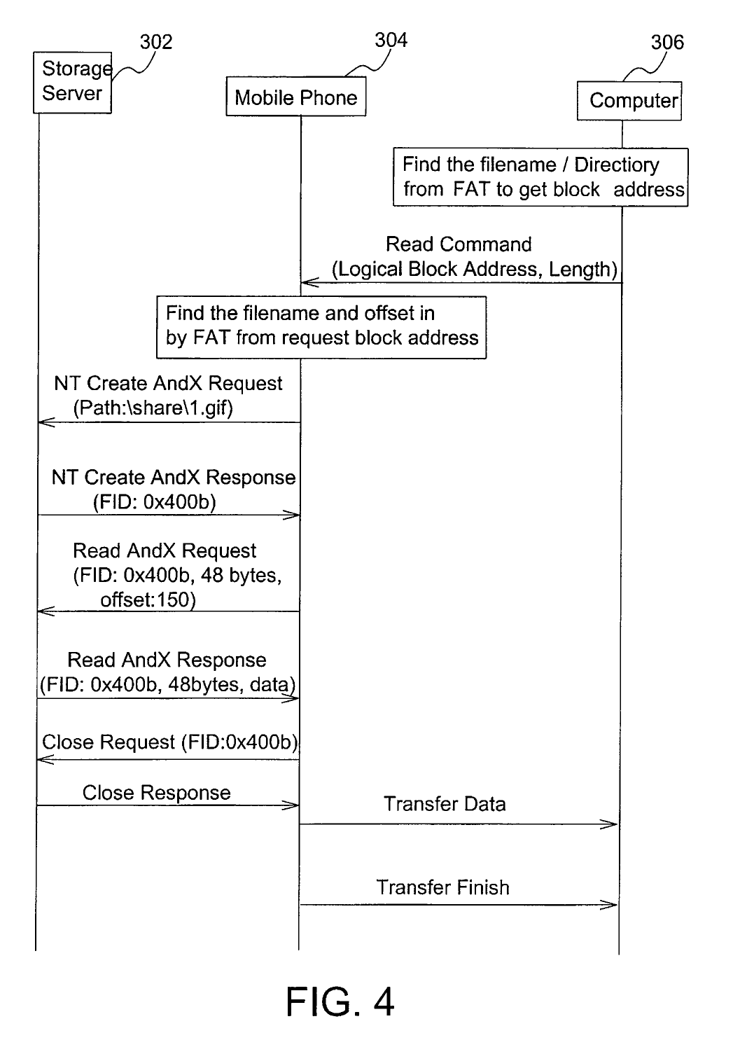

Referring to FIG. 4, in this embodiment, the virtual File Allocation Table created by the mobile phone 304 is transmitted to the computer 306. When the computer 306 desires to read a file, such as file “1.gif,” it can find the filename and directory of file “1.gif” from the virtual File Allocation Table to get the corresponding block address. Then, the computer 306 transmits a read command with the block address and length to the mobile phone 304. The mobile phone 304 can find the filename and offset by searching the mapping table according to the block address and length. In other words, the mobile phone 304 converts the block address and length into a file path and an offset. Next, the mobile phone 304 transmits a request with the file path (such as Path:\share\1.gif) to the storage server 302. Then, the mobile phone 304 receives a response containing a file identifier (such as FID:0x400b) from the storage server 302. Next, the mobile phone 304 transmits a read request with the information of file offset and file size (such as 150 offset and 48 bytes) to the storage server 302, and then receives the file “1.gif” from the storage server 302. Then, the communication between the mobile phone 304 and the storage server 302 is closed. Next, the file “1.gif” is transferred to the computer 306, and the read process is done.

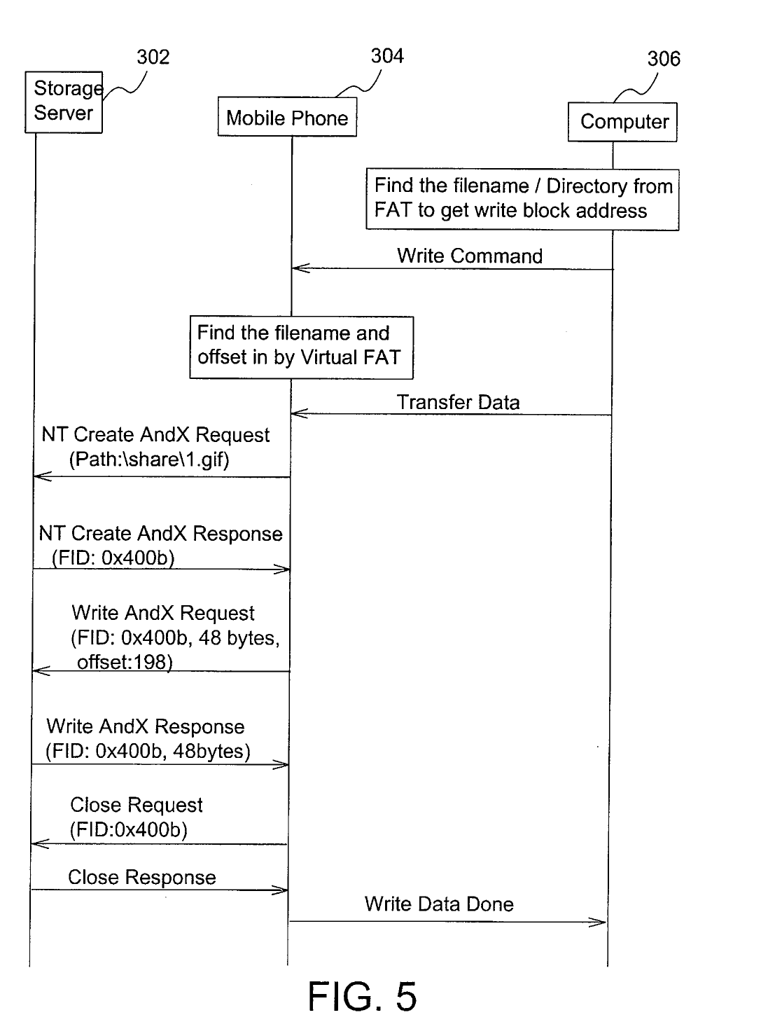

Referring to FIG. 5, when the computer 306 desires to write a file, such as file “1.gif,” it can find the filename and directory of file “1.gif” from the virtual File Allocation Table to get the corresponding block address. Then, the computer 306 transmits a write command with the block address and length to the mobile phone 304. The mobile phone 304 can find the filename and offset by searching the mapping table according to the block address and length. In other words, the mobile phone 304 converts the block address and length into a file path and offset. Then, the computer 306 transfers the data to be written to the mobile phone 304. Next, the mobile phone 304 transmits a request with the file path (such as Path:\share\1.gif) to the storage server 302. Then, the mobile phone 304 receives a response containing a file identifier (such as FID:0x400b) from the storage server 302. Next, the mobile phone 304 transmits a write request with the information of the data to be written (such as 198 offset and 48 bytes) to the storage server 302. The mobile phone 304 receives a write response from the storage server 302, and then the communication between the mobile phone 304 and the storage server 302 is closed. The mobile phone 304 informs the computer 306 that the write action is done.

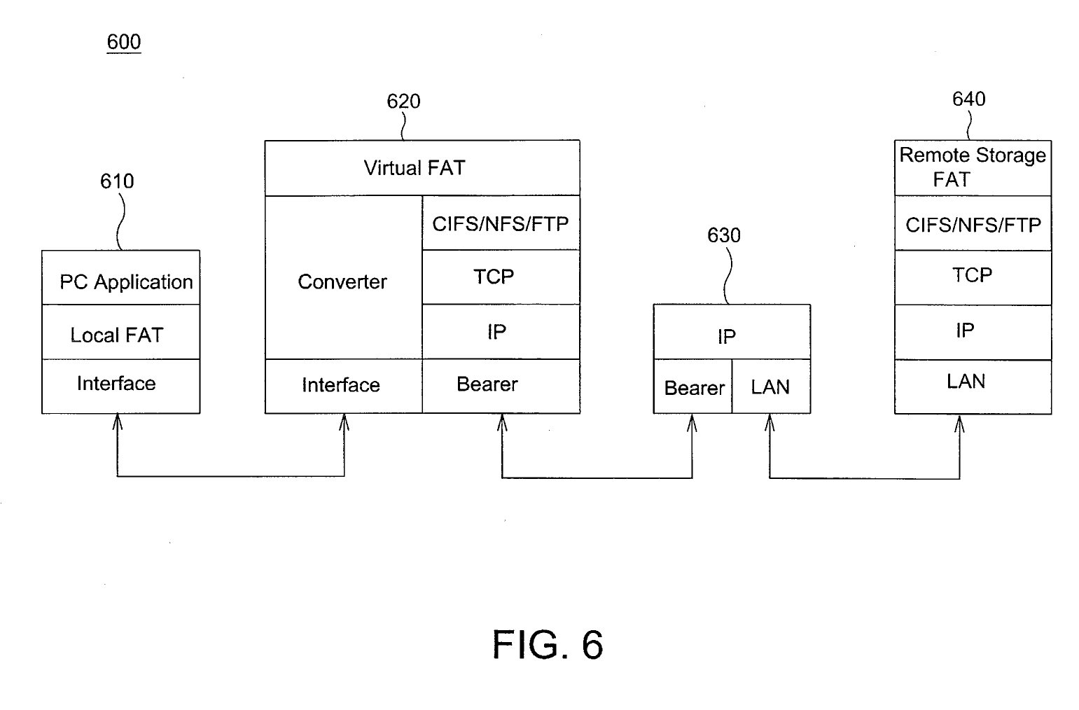

FIG. 6 illustrates a software architecture of a wireless virtual storage system 600 in accordance with one embodiment of the present invention. The wireless virtual storage system 600 includes a computer 610, a mobile phone 620, a transmission node 630, and a remote storage server 640. Both the mobile phone 620 and the remote storage server 640 have TCP/IP standard stacks, and communicate with the each other via the transmission node 630 by a transmission protocol, such as CIFS/NFS/FTP protocol, wherein the mobile phone 620 wirelessly connects to the transmission node 630 through message bearers, Such as 3G/WLAN bearers, and the transmission node 630 wirelessly connects to the remote storage server 640 through communication modules, such as Bluetooth modules or LAN modules. The mobile phone 620 communicates with the computer 610 by an interface protocol, such as USB/IEEE 1394 protocol. To build up a communication between the computer 610 and remote storage server 640, a mapping table between two different transmission formats is created by the mobile phone 620 according to the transmission protocol and the interface protocol. For example, under CIFS protocol, the transmission format is file path, while under USB protocol, the transmission format is block address. Therefore, when using CIFS protocol as transmission protocol and using USB protocol as interface protocol, the mobile phone 620 will create a mapping table between file path and block address. The mobile phone 620 may transmit a request to the remote storage server 640 for the file structure information of the remote storage server 640. After receiving the file structure information, the mobile phone 620 generates a virtual FAT, which may be a part of the FAT of the remote storage server 640. After generating the virtual FAT, the mobile phone 620 transmits the virtual FAT to the computer 610 as a part of the local file system of the computer 610 for allowing the computer 610 to access the data stored in the remote storage server 640.

In summary, the present invention provides a communication device capable of sharing data in a remote server with an electronic device by creating a mapping table between two different transmission formats according to a communication protocol between the communication device and the remote server and a communication protocol between the communication device and the electronic device. A user can store movies, music and photos in the remote server with great capacity of storage. When the user plugs his communication device to the electronic device through a communication interface, the electronic device can access the remote server without any modifications.

The present invention has been described above with reference to preferred embodiments. However, those skilled in the art will understand that the scope of the present invention need not to be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

What is claimed is:

1. A communication device capable of sharing data in a remote storage server with an electronic device, the electronic device communicating with the remote storage server via the communication device, the communication device comprising:
a wireless communication module for communicating with the remote storage server with a communication protocol;
an interface for communicating with the electronic device with an interface protocol; and
a converter for generating a mapping table between two different transmission formats according to the communication protocol and the interface protocol.

2. The communication device of claim 1, wherein a communication between the electronic device and the communication device is in a block address format, and a communication between the communication device and the remote storage server is in a file path format, wherein the mapping table is a mapping between the block address format and the file path format.

3. The communication device of claim 1, wherein a file structure information of the remote storage server is transmitted to the communication device, and a virtual File Allocation Table (FAT) is generated according to the file structure information of the remote storage server.

4. The communication device of claim 3, wherein the electronic device transmits a request to the communication device for the file structure information, and the communication device transmits a request to the remote storage server for the file structure information.

5. The communication device of claim 4, wherein the file structure information includes at least one of the system information, the information about a folder in the remote storage server, and the structure information under the folder.

6. The communication device of claim 3, wherein the electronic device gets a block address from the virtual FAT corresponding to a file in the remote storage server and transmits the block address to the communication device, and the communication device converts the block address into a file path according to the mapping table and transmits the file path to the remote storage server.

7. The communication device of claim 6, wherein the electronic device further transmits a length corresponding to the file in the remote storage server to the communication device, the communication device further converts the block address and the length into the file path and an offset according to the mapping table, transmits the file path and the offset to the remote storage server, and receives the file from the remote storage server.

8. The communication device of claim 6, wherein the electronic device further transfers data to be written to the communication device, and the communication device further transmits a write request with the information of the data to be written to the remote storage server.

9. The communication device of claim 3, wherein the virtual FAT is a part of a File Allocation Table (FAT) of the remote storage server.

10. The communication device of claim 1, wherein the communication protocol is a CIFS (common internet file system) protocol, a FTP (file transfer protocol) or a NFS (Network File System) protocol.

11. The communication device of claim 1, wherein the wireless communication module communicates with the remote storage server through GSM network, GPRS network, 3G network, WLAN, WiMax network, or IrDa network.

12. The communication device of claim 1, wherein the interface is a USB interface or an IEEE 1394 interface.

13. The communication device of claim 1, wherein the communication device may be a mobile phone or a PDA.

14. A method for a communication device to share data in a remote storage server with an electronic device, comprising:
establishing a communication with the remote storage server by a communication protocol;
establishing communication with the electronic device by an interface protocol; and
generating a mapping table between two different transmission formats according to the communication protocol and the interface protocol.

15. The method of claim 14, wherein the electronic device transmits a request in a block address format to the communication device, the method further comprises:
converting the request into a file path format according to the mapping table; and
transmitting the request in the file path format to the remote storage server.

16. The method of claim 14, further comprising:
transmitting a request to the remote storage server for requesting a file structure information of the remote storage server; and
generating a virtual File Allocation Table (FAT) according to the requested file structure information.

17. The method of claim 16, wherein the electronic device transmits a request to the communication device for the file structure information, the method further comprises:
transmitting a request to the remote storage server for the file structure information.

18. The method of claim 17, wherein the file structure information includes at least one of the system information, the information about a folder in the remote storage server, and the structure information under the folder.

19. The method of claim 16, wherein the electronic device gets a block address from the virtual FAT corresponding to a file in the remote storage server and transmits the block address to the communication device, the method further comprises:
converting the block address into a file path according to the mapping table; and
transmitting the file path to the remote storage server.

20. The method of claim 19, wherein the electronic device further transmits a length corresponding to the file in the remote storage server to the communication device, the method further comprises:
converting the block address and the length into the file path and an offset according to the mapping table;
transmitting the file path and the offset to the remote storage server; and
receiving the file from the remote storage server.

21. The method of claim 19, wherein the electronic device further transfers data to be written to the communication device, the method further comprises:
transmitting a write request with the information of the data to be written to the remote storage server.

22. The method of claim 14, wherein the virtual FAT is a part of a File Allocation Table (FAT) of the remote storage server.

23. The method of claim 14, wherein the communication protocol is a CIFS (common internet file system) protocol, a FTP (file transfer protocol) or a NFS (Network File System) protocol.

24. The method of claim 14, wherein the wireless communication module communicates with the remote storage server through GSM network, GPRS network, 3G network, WLAN, WiMax network, or IrDa network.

25. The method of claim 14, wherein the interface is a USB interface or an IEEE1394 interface.

26. The method of claim 14, wherein the electronic device is a notebook, a multiprocessor-based device, a microprocessor-based device, or a programmable consumer electronic device.
